(19) United States
(12) Patent Application Publication
(10) Pub. No.: US 2024/0383617 A1
(43) Pub. Date: Nov. 21, 2024

(54) METHOD AND DEVICE FOR MONITORING THE HEALTH OF A MECHANICAL SYSTEM OF A VEHICLE BY USING THRESHOLDS THAT VARY DEPENDING ON OPERATING PARAMETERS OF THE SYSTEM

(71) Applicant: AIRBUS HELICOPTERS, Marignane Cedex (FR)

(72) Inventors: Maxime MEUTERLOS, Marseille (FR); Lucas MACCHI, Eguilles (FR); Valerio CAMERINI, Marseille (FR)

(73) Assignee: AIRBUS HELICOPTERS, Marignane Cedex (FR)

(21) Appl. No.: 18/608,150

(22) Filed: Mar. 18, 2024

(30) Foreign Application Priority Data
May 15, 2023 (FR) 2304803

(51) Int. Cl. B64F 5/60; G08B 21/18

(52) U.S. Cl. CPC B64F 5/60; G08B 21/182; G08B 21/187

(57) ABSTRACT

A method for monitoring a mechanical system for a vehicle. During an initial phase, measurements are taken of vibration values from vibration sensors and context parameters from context sensors in order to determine several values of a health indicator CI relating to the mechanical system and a variation model of a threshold relating to this health indicator CI and variable as a function of the context parameters. Next, during a monitoring phase, measurements are taken once more of vibration values and context parameters in order to determine an operational value of the health indicator CI and a threshold specific to this health indicator CI by means of the threshold variation model and the measured context parameters. A fault presence alarm may then be triggered if there is a risk of presence of a fault in the mechanical system.

### CROSS-REFERENCE TO RELATED APPLICATION

This application claims priority to French patent application No. FR 2304803 filed on May 15, 2023, the disclosure of which is incorporated in its entirety by reference herein.

### TECHNICAL FIELD

The present disclosure lies in the field of systems for monitoring the health of mechanical systems.

### BACKGROUND

The present disclosure relates to a method and a device for monitoring the health of a mechanical system equipping a vehicle by using thresholds that vary depending on operating parameters of the system.

A mechanical system may comprise several moving members, for example several rotating members, such as an input shaft and an output shaft.

For example, a mechanical system may comprise one or more bearings for guiding an input shaft and an output shaft or one or more intermediate rotating members in rotation. A bearing comprises, for example, a rolling bearing provided with one or more rows of rolling elements such as balls, rollers or the like.

A mechanical system may also be provided with at least one toothed wheel, pinion or toothed ring gear.

The operation of a mechanical system may be monitored in order to detect an operating fault or anticipate the occurrence of a failure or malfunction. An aircraft may therefore comprise an onboard monitoring system for monitoring the health of a mechanical system so as to increase flight safety.

Irrespective of the mechanical system that is being monitored, such a monitoring system can measure and record operational data of the mechanical system, in particular data of a vibratory nature. This monitoring system can then determine values of health indicators as a function of this operational data and compare it to predefined thresholds in order to detect a potential anomaly linked to an incipient mechanical fault. The value of each threshold may be obtained by experiments or by statistical analysis of a history of measurements from several similar mechanical systems acquired during test or validation phases or indeed during the first hours of use of such a mechanical system. The thresholds may, for example, be estimated using parametric modelling of the statistics of the health indicator based on the assumption that the mechanical system is healthy, i.e., being free of anomalies, malfunctions or faults.

The value of each threshold may be constant over the entire operating range of the mechanical system. Each detection threshold may alternatively comprise several constant values relating respectively to specific operating phases of the mechanical system.

A health indicator may be in the form of a vibration indicator evaluated using at least one sensor, this sensor being able to comprise at least one accelerometer or tachometer. Such a health indicator may be defined using a signal supplied by a single sensor, for example being equal to the maximum amplitude of a temporal vibration signal supplied by an accelerometer, or by combining the signals of several sensors. This is the case, for example, of health monitoring systems known as Health and Usage Monitoring Systems (HUMS).

One health indicator may be used to monitor a mechanical system as a whole, while other health indicators may be specific to a particular type of fault that may occur in a particular member of the mechanical system.

Documents U.S. Pat. No. 7,684,936, US 2017/0023438, U.S. Pat. Nos. 8,442,778, 8,131,420, CN 102963533 and US 2011/0166799 describe Health and Usage Monitoring Systems (HUMS). Documents U.S. Pat. No. 8,442,778 and US 2017/0023438 are intended, in particular, for monitoring wind turbines. Documents U.S. Pat. No. 8,131,420, CN 102963533 and US 2011/0166799 are dedicated to rotary-wing aircraft.

In particular, document CN 102963533 discloses a monitoring system. This monitoring system comprises an onboard system for identifying a risk in real time and generating an alert, and a ground-based remote system capable of downloading and analyzing the data acquired in flight in order to plan the necessary maintenance operations.

Document US 2011/0166799 describes a monitoring system determining a health indicator whose value is adjusted as a function of an operating parameter of the mechanical system that is being monitored, and in particular as a function of a torque applied to a rotating member. This health indicator can then be compared to a threshold in order to estimate the risk of a fault occurring.

Such monitoring systems are useful but conventional health indicators are dependent on the operating conditions of the mechanical system. These operating conditions comprise, for example, context parameters. These context parameters are, for example, the altitude or forward speed of the aircraft, the torque applied in a gearbox, the rotational speed of a rotor, etc. This dependence can be reflected in a non-stationarity of the health indicators over the entire operating range of the mechanical system and/or the aircraft. Therefore, these health indicators may only be of use during specific operating modes. As a result, the monitoring of the health of a mechanical system may be restricted to certain periods of use, excluding any transient operating mode, in particular, that may delay the detection of a fault, or conversely lead to the detection of false failures.

The aim of specific methods applied to health indicators is to improve fault detection, in particular by taking into account the conditions wherein the mechanical system is operating.

For example, document EP 2345894 describes a method for indicating a fault propagating in a rotating shaft. After taking measurements of data corresponding to a health indicator of the shaft and measurements of an input factor, for example a torque applied to the shaft, a relationship between the health indicator and the input factor is determined. A filtered health indicator is then determined based on this relationship and an effect of the input factor on the health indicator, this effect being estimated using a Kalman filter, a recursive least squares estimation and/or a particulate filter.

Document EP 4091945 describes a method for detecting faults in an aircraft transmission system. This method proposes acquiring, over several time windows, a signal relating to the dynamic behavior of the transmission system and values of flight parameters of the aircraft. Groups of indicators relating to each time window are determined based on these signals. An estimate of the probability that the values of the indicators of a group of indicators are abnormal in relation to a predefined learning condition is calculated for each indicator of the group of indicators, taking the measured flight parameters into account. Health indicators are determined as a function of this estimate of the probability, then compared with a threshold in order to identify the presence of a fault.

Document WO 2011/023596 describes a method and a system for monitoring vibrations in a wind turbine. A range of characteristic vibration values is predicted based on real-time operating data of an electrical power generation means of the wind turbine, according to rules extracted from a set of rules. The characteristic operating values of the electrical power generation means are compared in real time with a calculated threshold in order to detect and signal the possible presence of a fault in the electrical power generation means.

Document CN 107218997 describes a method for detecting faults in a hydro-electric generating set based on identifying the operating conditions of the hydro-electric generating set. Historical vibration data is used to estimate a threshold. A signal indicating the operating status of the hydro-electric generating set is acquired in order to determine the operating conditions of the hydro-electric generating set. An anomaly can therefore be detected sensitively on the basis of the historical vibration data and the operating status identified by the status signal when the vibration values pass the threshold.

Document US 2022/0163428 discloses a system and a method for monitoring the state of a gas turbine damper. Such a gas turbine comprises a rotating component, a rolling bearing functionally coupled to this rotating component, and a damper associated with the rolling bearing, as well as sensors and a controller. The controller receives data relating to detected and/or calculated parameters, and generates an index relating to the damper based on this data and characteristic of a state of health of the damper. When this index passes a predetermined threshold, a notification is generated indicating the state of health of the damper. A type of fault sustained by the damper and a remaining service life of the damper can also be determined.

### SUMMARY

The aim of the present disclosure is therefore to propose innovative method and device intended to monitor a mechanical system of a vehicle in order to detect, as early as possible, the occurrence of a fault in the mechanical system, while limiting the risk of false fault detection.

The object of the present disclosure is, for example, a method for monitoring the health of a mechanical system equipping a vehicle, the mechanical system comprising at least one moving member and at least one vibration sensor emitting a vibration signal, the mechanical system or the vehicle comprising at least one context sensor emitting a context signal relating to at least one context parameter, said at least one context parameter being chosen from a list comprising at least one or several functional parameters of the mechanical system, one or several navigation parameters of the vehicle and one or several atmospheric parameters.

This method consists of an initial phase of defining a threshold variation model as a function of said at least one context parameter, this initial phase being followed by a phase of operational monitoring of the mechanical system.

The initial phase comprises the following steps:
taking measurements of successive initial vibration values with said at least one vibration sensor and successive initial context values with said at least one context sensor;
determining, with a calculator, several initial health values of at least one health indicator CI relating to the mechanical system as a function of the initial vibration values, each initial health value being associated with one of the initial context values of said at least one context parameter; and
defining, for each health indicator CI, a threshold variation model, the threshold variation model being defined as a function of the initial health values of the health indicator CI and the initial context values of said at least one context parameter, by partitioning a domain formed by the initial context values of said at least one context parameter into several ranges of values for which the threshold relating to the health indicator CI is statistically constant over each range of values, each range being associated with several of the initial context values, and by determining values of the threshold with a method using regressions on parameters of quantile distributions conditioned on context parameters and domain decompositions of said at least one context parameter using at least one decision tree.

The operational monitoring phase comprises the following steps during the operation of the mechanical system:
taking measurements of successive operational vibration values from said at least one vibration sensor, and successive operational context values from said at least one context sensor;
determining, with the calculator, an operational health value of at least one health indicator CI as a function of the operational vibration values, the operational health value of a health indicator CI being associated with one of the operational context values relating to one or several context parameters;
determining the threshold specific to the operational health value of said at least one health indicator CI using the threshold variation model and said at least one associated operational context value; and
triggering an alert signaling a risk of presence of a fault in the mechanical system if the operational health value of said at least one health indicator CI is greater than the determined threshold.

To this method, one or several health indicators CI are determined during the initial phase based on measurements from said at least one vibration sensor, and a threshold variation model is then defined for each health indicator CI as a function of the values of this health indicator CI and the measurements from said at least one context sensor over this initial phase by means of regressions on parameters of quantile distributions. In order to define this variation model, at least one decision tree is used in order to define one or several ranges of the context parameter or parameters for which the threshold relating to the health indicator CI is statistically constant. A threshold relating to a health indicator CI is considered to be statistically constant, over a range of contiguous values of a context parameter, if, for any division of said range of values into two sub-ranges of contiguous values, the thresholds estimated respectively over the two sub-ranges of values are considered identical according to a statistical test. Such a statistical test may be a Welch's t-test, for example.

The term “each” is used for convenience, both in the case of a single health indicator CI and in the case of health indicators CI, in order to facilitate reading.

The initial phase may therefore be a learning period that can be used to define the threshold variation model for each health indicator CI of the mechanical system. This initial phase is carried out following the first use of the vehicle or indeed following a major maintenance operation, for example after replacing the mechanical system. During this learning period, the mechanical system is considered to be free of faults. This initial phase is thus used to determine the threshold variation model of the mechanical system that is considered to be healthy for the vehicle.

Following this learning period and after defining the threshold variation model, the health of the mechanical system is monitored using the threshold variation model during the operational monitoring phase. The method according to the disclosure therefore makes it possible to adapt the value of the threshold with which a health indicator CI is compared to the context parameters, that helps s improve the detection of a mechanical fault or an anomaly linked to an incipient mechanical fault, while reducing the false detection rate.

The reliability and availability of the mechanical system and the vehicle equipped with this system are therefore improved by virtue of the method according to the disclosure, compared with conventional monitoring methods wherein the threshold is generally algebraically constant over the entire range of use of the vehicle.

Furthermore, the context parameters may comprise operating parameters of the mechanical system, such as the rotational speed of one or several rotating shafts, the torque or torques at this or these shafts or the temperature of the mechanical system, for example.

The context parameters may comprise operating parameters of the vehicle, and in particular of an aircraft, equipped with the mechanical system, such as the forward speed of this vehicle, its vertical speed, if applicable, its altitude, or the rotational speed of a rotor, for example.

The context parameters may also comprise atmospheric parameters, such as the temperature and the atmospheric pressure outside the mechanical system, for example.

Therefore, the context sensor or sensors make it possible to measure context characteristics relating to the operation of the mechanical system, and/or the vehicle per se, and relating to the surrounding environment, and to emit a temporal context signal carrying information relating to these context characteristics to a calculator, for example. The temporal context signal carries initial context values during the initial phase of defining a threshold variation model, and operational context values during the phase of operational monitoring of the mechanical system.

The vibration signal and the context signal may be generated simultaneously or in a synchronized manner.

A calculator may be present in the vehicle or present on a station that is separate from the vehicle. The vibration and context signals may be stored in a memory of the calculator or in a memory present in the vehicle and possibly connected to the calculator via a wired or wireless link, for example.

The method according to the disclosure may comprise one or more of the following features, taken individually or in combination.

According to one example, the threshold variation model may be defined using a single decision tree. Alternatively, the threshold variation model may be defined by aggregating at least two decision trees.

According to another example compatible with the preceding examples, the threshold variation model may be defined with a predetermined minimum rate of false alarms and a predetermined level of confidence in the minimum rate of false alarms. Using this minimum rate of false alarms, corresponding to a probability of emitting false alarms, therefore makes it possible to reduce the false detection rate and, consequently, the false alarm emission rate, thus limiting the downtime of the mechanical system and the vehicle when no fault is present.

According to another example compatible with the preceding examples, the initial phase may comprise an analysis step for analyzing the sensitivity of each health indicator CI to the context parameters and for selecting influential context parameters. This analysis step is carried out after determining several initial health values of each health indicator CI and before defining a threshold variation model.

Therefore, the context parameters that have the most influence on the variations of each health indicator CI are determined and selected during this analysis. As a result, only these selected context parameters are taken into account when defining the threshold variation model for each health indicator CI and, subsequently, for determining the variable threshold.

Alternatively, the initial phase may a comprise preselection step for selecting context parameters taken into account by the method from a plurality of context parameters measured by context sensors. This preselection step is carried out before taking measurements of the initial vibration and context values.

In this case, the context parameters that have the most influence on the variations of each health indicator CI are selected before carrying out the initial phase, for example by empirical analysis of measurements on other equivalent or similar mechanical systems, for example. As a result, only these previously selected context parameters are taken into account when defining the threshold variation model for each health indicator CI and, subsequently, for determining the variable threshold.

According to another example compatible with the preceding examples, said initial values of said at least one health indicator CI may be calculated from a decomposition, into Fourier coefficients, of the successive initial vibration values modelled with an assumption of first-and second-order cyclostationarity of the vibration signal, that follows a chi-squared distribution, generalized by a gamma distribution.

The present disclosure also relates to a computer program comprising instructions that, when the program is run, result in the implementation of the different examples of the monitoring method described above. This computer program may be stored, for example, in a memory of a calculator present in the vehicle, or in a memory located in the vehicle and connected to the calculator, or indeed in a memory of a station that is separate from vehicle.

This computer program may be implemented entirely by a calculator present in the vehicle or a computing device of the vehicle, or jointly by such a calculator or computing device present in the vehicle and by a station that is separate from vehicle.

The present disclosure also relates to a monitoring device configured to monitor a mechanical system equipping a vehicle, the mechanical system comprising at least one moving member, the monitoring device comprising at least one vibration sensor emitting a vibration signal, at least one context sensor emitting at least one context signal relating to at least one context parameter and a calculator.

The monitoring device is configured to implement the different examples of the health monitoring method described above.

Furthermore, the calculator may comprise a single computing unit on board the vehicle. Therefore, the entire monitoring method may be carried out in the vehicle, both when the vehicle is stopped or in operation.

Alternatively, the calculator may comprise a single computing unit that is separate from the vehicle and present, for example, in a station outside the vehicle. In this case, the step of taking measurements of the initial vibration values and the initial context values is carried out in the vehicle while it is operating during the initial phase of defining a threshold variation model, after which the station receives these initial vibration values and these initial context values, the computing unit of the station carrying out the steps of determining the initial health values of each health indicator CI, and of defining the threshold variation model. During the operational phase, the step of taking measurements of the operational vibration values and the operational context values is carried out in the vehicle while it is operating, whereas the steps of determining the operational health value of each health indicator CI, determining the threshold specific to the operational health value of each health indicator CI, and triggering an alert signaling a risk of presence of a fault in the mechanical system if the operational health value of at least one health indicator CI is greater than the determined threshold, are carried out by the computing unit of the station.

Alternatively, the calculator may comprise a computing unit on board the vehicle and a computing unit that is separate from the vehicle and present, for example, in a station outside the vehicle. In this case, the step of taking measurements of the initial vibration values and the initial context values in the initial phase and the step of taking measurements of the operational vibration values and the operational context values in the operational phase are carried out in the vehicle while it is operating. The other steps of the method may be carried out either in the vehicle while it is operating or when it is stopped, or in the station outside the vehicle that receives these initial vibration values and these initial context values as well as these operational vibration values and these operational context values.

The present disclosure also relates to a mechanical system comprising at least one moving member and one monitoring device as described above. This mechanical system may, for example, be a gearbox of a vehicle, and in particular of an aircraft.

The present disclosure also relates to a vehicle and, in particular, an aircraft, comprising such a mechanical system.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a schematic side view of an aircraft;

FIG. 2 is a diagram showing a process of monitoring a mechanical system according to the disclosure;

FIG. 3 is a diagram showing a method for monitoring a mechanical system according to the disclosure;

FIG. 4 is a diagram showing a histogram of a health indicator conditioned on a context parameter;

FIG. 5 is a diagram showing a single decision tree associated with two context parameters;

FIG. 6 is a diagram showing the separation of a data block relating to the values of a health indicator into a space of two context parameters;

FIG. 7 shows a curve representing the variation of the Welch's t-test statistic as a function of a context parameter;

FIG. 8 is a diagram showing a two-dimensional discretization of a data block as a function of two context parameters;

FIG. 9 is a diagram showing an aggregation of decision trees;

FIG. 10 is a diagram showing a threshold variation model; and

FIG. 11 is a graph showing curves of a variable threshold.

### DETAILED DESCRIPTION

Elements that are present in more than one of the figures are given the same references in each of them.

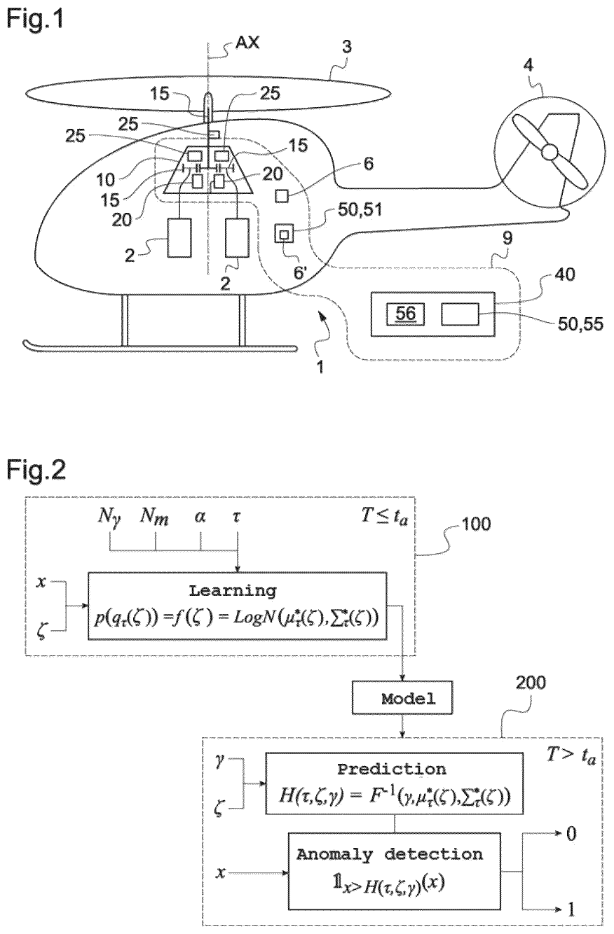

FIG. 1 shows a vehicle 1 and, in particular, a rotary-wing aircraft such as a rotorcraft. This vehicle 1 comprises a mechanical system 10 provided with one or more moving members 15. These members 15 rotate, for example, about a rotation axis AX.

The mechanical system 10 may, for example, comprise an output shaft or an input shaft. The mechanical system 10 may also comprise one or several rotational guide bearings, for example, for guiding at least one rotating member in rotation. A bearing comprises a rolling bearing provided with rolling elements, for example.

The mechanical system 10 may also comprise, for example, at least one toothed wheel, pinion or toothed ring gear, that may be fixed or mobile.

A mechanical 10 may, system for example, be a transmission or a gearbox of the vehicle 1. This mechanical system 10 may be connected, for example, to one or several engines 2, via one or several input shafts respectively, and may rotate a rotor such as, for example, a main rotor 3 or an auxiliary rotor 4 of a rotorcraft, via an output shaft, as shown in FIG. 1. According to another example, a mechanical system 10 may be a rotary wing.

Alternatively, such a mechanical system 10 may, for example, be arranged in a transmission or gearbox of a vehicle 1 or any other piece of mechanical equipment.

These examples are given simply in order to illustrate the disclosure.

Irrespective of its arrangement, the mechanical system 10 also comprises a monitoring device 9 intended to monitor the mechanical system 10 in order to detect and identify the presence of a fault, or a risk of a fault occurring.

The monitoring device 9 comprises one or several vibration sensors 20, one or several context sensors 25 and a calculator 50. The calculator 50 may be dedicated to the monitoring device 9 or be shared with other devices of the vehicle 1.

Each vibration sensor 20 can emit a temporal vibration signal relating to vibrational behavior of the mechanical system 10 as a whole, or to particular vibrational behavior of a member 15 of the mechanical system 10, for example a shaft, a bearing or a gear. The temporal vibration signal carries successive vibration values relating to the vibrations of the mechanical system 10, at a sampling frequency, for example. The vibration sensor or sensors 20 may comprise, for example, an accelerometer, a tachometer or the like.

Each context sensor 25 can emit a temporal context signal relating to a context characteristic linked to the operation of the mechanical system 10 and/or the vehicle 1 and to the surrounding environment. The temporal context signal carries successive context values relating to a context parameter linked to the mechanical system 10, the vehicle 1 and/or the surrounding environment, at a sampling frequency, for example.

The context parameters may comprise operating parameters of the mechanical system 10, such as the rotational speed of one or several rotating shafts, the torque or torques at this or these shafts or the temperature of the mechanical system 10, for example. One or more context sensors 25 may then comprise different types of sensors associated with each operating parameter of the mechanical system 10, such as, for example, an accelerometer, a tachometer, a torquemeter, or the like. One or more context sensors 25 may also comprise an angular sensor, such as an encoder sensor, that can be used to measure a variation in the angular position of a rotating member 15 of the mechanical system 10, for example in order to synchronize the vibration signals and the context signals with the rotation and the angular positions of this rotating member 15. If the vehicle 1 is an aircraft, the context parameters may be managed by an onboard system referred to as a Usage Monitoring System (UMS).

The context parameters may comprise operating parameters of the vehicle 1, such as its forward speed, its vertical speed, its altitude, or the rotational speed of a rotor 3,4, for example. One or more context sensors 25 may then comprise different types of sensors associated with each operating parameter of the vehicle 1, such as, for example, an accelerometer, a tachometer, an altimeter or the like.

The context parameters may also comprise atmospheric parameters linked to the atmospheric conditions, such as the temperature outside the mechanical system 1 and the atmospheric pressure, for example. One or more context sensors 25 may then comprise a thermometer and/or a barometer, for example.

Furthermore, the calculator 50 may comprise a single computing unit 51 on board the vehicle 1.

Alternatively, the calculator 50 may comprise a single computing unit 55 that is separate from the vehicle 1 and present, for example, in a station 40 outside the vehicle 1.

Alternatively, the calculator 50 may comprise a computing unit 51 on board the vehicle 1 and a computing unit 55 that is separate from the vehicle 1 and present, for example, in a station 40 outside the vehicle 1.

Each computing unit 51,55 may comprise at least one processor and at least one memory 6′, at least one integrated circuit, at least one programmable system or indeed at least one logic circuit, these examples not limiting the scope given to the expression “computing unit”. The calculator 50 may also be connected to a memory 6′,56 present in the vehicle 1 or in the station 40, via a wired or wireless link. The calculator 50 may also comprise a memory 6′.

The vibration and context signals may thus be stored in the memory 6,6′ after having been transmitted to this memory 6,6′, via a wired or wireless link, the vibration and context signals being able to be analog, digital, electrical or optical signals.

The memory 6,6′,56 may also store a computer program comprising instructions that, when the program is run, cause a method for monitoring the health of the mechanical system 10 to be carried out. This method for monitoring the health of the mechanical system 10 is dedicated to monitoring the health, for example the vibratory health, of the mechanical system 10.

Furthermore, each vibration sensor 20 and each context sensor 25 may continuously emit a vibration signal and a context signal respectively.

A vibration signal and a context signal may be signals formed by raw measurements emitted respectively by a vibration sensor and a context sensor or by measurements obtained by relatively complex signal processing carried out by a processing unit, for example integrated into the corresponding sensor, on such raw measurements, for example via conventional filtering or sampling, or the application of transformations.

The method for monitoring the health of the mechanical system 10 according to the disclosure comprises two phases 100,200 as shown in the diagram in FIG. 2.

During an initial phase 100, a threshold variation model H is defined, the threshold varying as a function of the context parameter or parameters and being intended to be compared with a health indicator CI for monitoring the health of the mechanical system 10. Next, an operational monitoring phase 200 is carried out, wherein the mechanical system 1 is monitored using the threshold determined with the model as a function of the context parameter or parameters. During the initial phase 100, the mechanical system 10 is considered healthy, and therefore free of anomalies and faults.

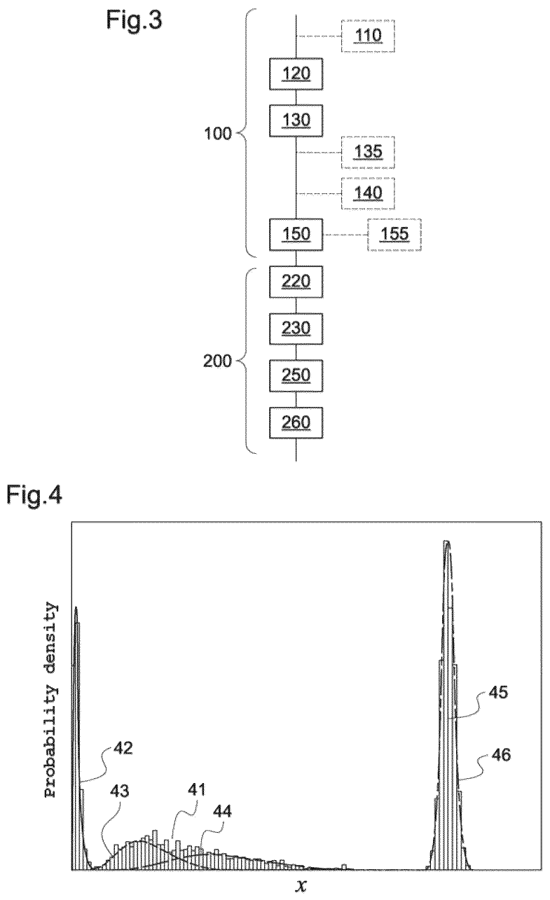

The initial phase 100 comprises several steps, as shown in FIG. 3.

The initial phase 100 may first comprise a preselection step 110 for selecting context parameters taken into account by the method from a plurality of context parameters measured by the context sensor or sensors 25. Indeed, a very high number of context parameters, for example more than 1000 context parameters, may be measured on complex systems, and in particular on a vehicle 1 like an aircraft. Therefore, in order to limit the context parameters used by the method according to the disclosure, only some of these measured context parameters are taken into account. This selection may be made based on feedback from similar mechanical systems or vehicles, the selected context parameters being the parameters that have the most influence for these similar mechanical systems or vehicles. The selected context parameters may be stored in the memory 6,6′,56.

This preselection step 110 is not essential in order to carry out the method according to the disclosure and is therefore optional.

During a step of taking measurements 120, successive initial vibration values and initial context values from the vibration sensor or sensors 20 and the context sensor or sensors 25 respectively are measured and transmitted to the onboard memory 6,6′ in order to be stored there and/or are transmitted directly to the computing unit 51.

Next, during a determination step 130, several initial health values of each health indicator CI are determined in a conventional manner as a function of the initial vibration values measured during the step of taking measurements 120, by means of the calculator 50. The various initial health values of each health indicator CI correspond respectively to different instants of the initial phase 100.

An initial health value of a health indicator CI is, for example, equal to an initial value from a single vibration sensor 20 or the result of a law involving initial values from several vibration sensors 20 respectively. If the vehicle 1 is an aircraft, these initial health values of health indicators CI are, for example, determined by means of a system referred to as a Health Monitoring System (HMS).

Moreover, each initial health value of a health indicator CI is then associated with the initial context value of the one or several context parameters measured substantially simultaneously with the initial vibration value or values used to determine the initial health value of this health indicator CI. For example, an initial health value of a health indicator CI is associated with an initial context value of three distinct context parameters.

This determination step 130 may be carried out by the computing unit 51 of the calculator 50 that is on board the vehicle 1. Each initial value of a health indicator CI may then be stored in the onboard memory 6,6′. Each initial value of the health indicator or indicators CI may therefore be calculated while the vehicle 1 is being used, substantially in real time, or indeed when the vehicle 1 is stopped.

Alternatively, this determination step 130 may be carried out by the computing unit 55 of the calculator 50 of the station 40, once the vehicle 1 is stopped and, for example, is resting on the ground, in the case of an aircraft. To this end, the initial context values and the initial vibration values are transmitted from the memory 6,6′ present in the vehicle 1 to the computing unit 55, via a wired or wireless link, in the form of analog, digital, electrical or optical signals, for example, or indeed by means of a memory card, during a transmission step 135, once the vehicle 1 is stopped. The initial context values and the initial vibration values may then be stored in the memory 56 of the station 40. Each initial value of the health indicator or indicators CI may therefore be calculated after using the vehicle 1, by the computing unit 55, each initial value of a health indicator CI being able to be stored in the memory 56.

The initial phase 100 may then comprise, as an alternative or in addition to the preselection step 110, an analysis step 140 for analyzing the sensitivity of each health indicator CI to the context parameters and for selecting influential context parameters. This analysis step can be used to determine and select, from the context parameters that are used, the context parameters that have the most influence on the variations of each health indicator CI. This analysis step 140 may be carried out by the computing unit 51 on board the vehicle 1 or by the computing unit 55 of the calculator 50 of the station 40.

During a definition step 150, a threshold variation model H is defined for each health indicator CI as a function of the initial health values of this health indicator CI, considered to characterize a healthy mechanical system 10, and the previously determined and stored initial context values of the context parameter or parameters. This definition step 150 requires a high number of initial health values for each health indicator CI in order for this threshold variation model H to be reliable and robust. This high number of initial health values needs to cover a large portion of the range of use of the vehicle 1, so that a reliable and safe threshold can be determined for the entire range of use of the vehicle 1. This high number of initial health values is obtained during a minimum learning period ta wherein the vehicle 1 is being used, for example equal to 50 hours, substantially corresponding to the duration of the initial phase 100.

This definition step 150 may be carried out by the computing unit 51 of the calculator 50 on board the vehicle 1, with the initial values of the health indicator or indicators CI and initial context values stored in the memory 6,6′. The initial context values and the initial values of the health indicator or indicators CI are transmitted from the memory 6,6′ to the calculator 50, for example via a wired or wireless link, in the form of analog, digital, electrical or optical signals, during a transmission sub-step 155, for example while the vehicle 1 is operating or once the vehicle 1 is stopped. The threshold variation model H may then be stored in the memory 6,6′ present in the vehicle 1.

Alternatively, this definition step 150 may be carried out by the computing unit 55 of the calculator 50 of the station 40, with the initial values of the health indicator or indicators CI and initial context values stored in the memory 6,6′ of the vehicle 1, after the vehicle 1 has stopped. The initial context values and the initial values of the health indicator or indicators CI are in this case transmitted from the memory 6,6′ present in the vehicle 1 to the computing unit 55 of the station 40, for example during a transmission sub-step 155. The threshold variation model H may then be stored in the memory 56 of the station 40.

Alternatively, this definition step 150 may also be carried out by the computing unit 55 of the station 40, with the initial values of the health indicator or indicators CI and initial context values stored in the memory 56 of the station 40, after the vehicle 1 has stopped. The threshold variation model H may then be stored in the memory 56 of the station 40.

The threshold model H is dependent on the context parameters ζ and can be expressed as H(τ,ζ,γ)=ƒ⁻¹(ζ), wherein τ is a level of probability of the quantile distribution, corresponding to a requested false alarm rate;
γ is a level of uncertainty in the estimated threshold H, corresponding to a level of confidence in this requested false alarm rate; and
ƒ⁻¹(ζ) is an inverse cumulative function of a log-normal distribution as a function of ζ.

For the record, a variable X is said to follow a log-normal distribution if the variable Y=log(X) follows a normal distribution.

The function ƒ(ζ) can be estimated with a method using decision tree regressions on the parameters of quantile distributions via an aggregation of decision trees often referred to as “bagging” decision trees.

A quantile q_{τ} is a value that separates a data set according to a proportion defined by a probability τ. For a set of context parameters ζ, the function ƒ(ζ) is a probability density that characterizes the quantile distribution p(q_{τ}(ζ)) as a function of the context parameters ζ. The quantile distribution p(q_{τ}(ζ)) is defined by the mean μ*_{τ}(ζ) and the variance Σ*_{τ}(ζ). The function ƒ(ζ) thus characterizes the relationship between the quantile distributions and the context parameters ζ.

The function ƒ(ζ) can then be written as follows:

$$f ( ζ ) = p ( {q}_{τ} ( ζ ) ) = Log N [ {μ}_{τ}^{*} ( ζ ) , {Σ}_{τ}^{*} ( ζ ) ] .$$

The mean μ*_{τ}(ζ) and the variance Σ*_{τ}(ζ) can be estimated from the image of the function ƒ(ζ) for a space of context parameters ζ of dimension p, p also being the number of context parameters ζ used. Therefore, if two different context parameters ζ are used, they form a two-dimensional context parameter space.

The method according to the disclosure may use statistical modelling of the distribution of the health indicator CI. Furthermore, it is known that the health indicators CI estimated from the Fourier coefficients of a vibration signal modelled under the assumption of first-order and second-order cyclostationarity follow a chi-squared distribution, when the mechanical system 10 is free of faults. The generalization of this distribution is a gamma distribution Γ with two parameters, a shape parameter α and a scale parameter β. The statistical distribution of the health indicator CI is thus modelled by a mixture of gamma distributions. This type of modelling advantageously makes it possible to consider more complex data distributions and therefore offers greater flexibility. The probability density of such a mixture of gamma distributions for the value x of the health indicator CI can be written as follows:

$$p ( x ) = {Σ}_{n = 1}^{K} {π}_{n} \cdot p ( x ; {α}_{n} , {β}_{n} ) ,$$

π being a mixture coefficient, and where the distribution p(x;αₙ,βₙ) is a gamma distribution such that:

$$p ( x ; {α}_{n} , {β}_{n} ) = \frac{1}{{β}_{n}^{{α}_{n}} \cdot Γ ( {α}_{n} )} {x}^{n - 1} \cdot {e}^{\frac{- x}{{β}_{n}}} ,$$

wherein Γ( ) is the gamma function, and
K is the number of gamma distributions.

The parameters of the mixture model {αₖ,βₖ,πₖ} are estimated with an expectation maximization algorithm whereas the number of gamma distributions K is estimated from a Bayesian Information Criterion (BIC), with the condition K≤N_{γ} wherein Nγ is the maximum number of components of the gamma distribution to be estimated.

Once the mixture model has been estimated, it is possible to estimate the quantile at a probability level τ, by defining a cumulative distribution Fₓ(t) such that:

$${F}_{X} ( t ) = {\int }_{0}^{t} {Σ}_{n = 1}^{K} {π}_{n} \cdot p ( x ; {α}_{n} , {β}_{n} ) dx .$$

The estimation of the quantile q_{τ} calculated for a probability level τ involves solving the problem of unconstrained optimization according to which q_{τ}=argminₜ|g_{τ}(t)|,
wherein g_{τ}(t)=|Fₓ(t)−τ|=|∫₀^{t}Σₖ₌₁^{K}πₙ.p(x;αₙ,βₙ)dx−τ|.

For the record, the argument minimum (argmin) of a function represents the value of the variable for which the value of the function in question reaches its minimum, the value for which the function is minimized being unique.

First of all, it is necessary to estimate the parameters of the quantile distribution. Firstly, parametric modelling of the health indicator CI conditioned on one or several context parameters is carried out using a mixture of gamma distributions. A weighted Likelihood Bootstrap (WLB) method is then used to determine the uncertainties in the parameters of the mixture of gamma distributions. At each sampling using the WLB method, a quantile value q_{τ} is estimated. This sampling step is carried out p times in order to obtain a sample of quantile value q_{τ}, referred to as Q_{τ}={q_{τ}_{₁}, . . . , q_{τ}_{_{P}}}.

The quantity q_{τ}˜log N(μ*_{τ},Σ*_{τ}) is now considered to be a random variable modelled by a log-normal distribution with the following parameters: μ*_{τ},Σ*_{τ}.

It is then possible to calculate a mean:

$${μ}_{τ}^{*} = log ( \frac{{μ}_{τ}^{2}}{\sqrt{{Σ}_{τ} + {μ}_{τ}^{2}}} ) , and {μ}_{τ} = \frac{1}{{N}_{b}} {\sum }_{k = 1}^{{N}_{b}} {q}_{{τ}_{k}} ,$$

and a variance:

$${Σ}_{τ}^{*} = log ( \frac{{Σ}_{τ}}{{μ}_{τ}^{2}} + 1 ) and {Σ}_{τ} = \frac{1}{{N}_{b}} {\sum }_{k = 1}^{{N}_{b}} {( {q}_{{τ}_{k}} - {μ}_{τ} )}^{2} .$$

FIG. 4 shows a histogram 41 of the probability density of a health indicator CI, according to the value x of this health indicator CI. The curves 42,43,44 represent the variations in the gamma components identified by the mixture model according to the value x of this health indicator CI. The histogram 45 corresponds to the estimated quantile sample modelled by a log-normal distribution 46.

Furthermore, in order to enable the construction of a regression model via decision trees, the method performs recursive division of the space of the context parameters in order to divide it into several ranges for which the threshold relating to the health indicator CI is statistically constant, i.e., for a range of values of a given context parameter, two distinct thresholds resulting from a further division of the range of values of the context parameter into two sub-ranges have, for example, a statistical deviation that is less than a predetermined value. This predetermined value is, for example, equal to the critical value of the Welch's t-test statistic. Such a division criterion makes it possible to reduce the dissimilarity of the quantile distributions over the space of the context parameters, for example.

The method according to the disclosure may make it possible, for example, to express the conditional variability of the health indicators CI based on the variability of the quantile distributions, the dissimilarity of the quantile distributions over the space of the context parameters being estimated on the basis of a similarity statistic or Welch's t-test statistic Sⱼ(k) between two quantile distributions characterized by their respective means μ_{τ}_{₁} and μ_{τ}_{₂} and also by their respective variances Σ_{τ}_{₁} and Σ_{τ}_{₂} according to the following relationship:

$${S}_{j} ( k ) = \frac{\vert {μ}_{{τ}_{1}} ( k ) - {μ}_{{τ}_{2}} ( k ) \vert}{\sqrt{\frac{{Σ}_{{τ}_{1}} ( k ) + {Σ}_{{τ}_{2}} ( k )}{{N}_{b}}}} .$$

The indices j and k respectively designate the index j of the context parameter ζj, j varying from 1 to p, and the iteration indicating the path index k on this context parameter ζj, Nb being the dimension of the quantile sample Q_{τ}. The path index k is an iterator indexed on the vector defined by the context parameter ζj. The means of the samples Q_{τ} of quantiles μ_{τ}_{₁}(k) and μ_{τ}_{₂}(k) as well as the variances Σ_{τ}_{₁}(k) and Σ_{τ}_{₂}(k) are estimated from the health indicator CI conditioned on the context parameter ζj at the path index k.

A maximum value of the Welch's t-test statistic may be determined over the entire space of the context parameters and makes it possible to determine the value of the context parameter and the context parameter to be discretized. A discretization coordinate ζ_{j*}^{k*} may then be chosen that is equal to the maximum value of the Welch's t-test statistic according to the context parameter ζj and the path index k, such that:

$${ζ}_{{j}^{*}}^{{k}^{*}} = arg {max}_{j , k} [ {S}_{j} ( k ) ] ,$$

wherein the function argmax(S) gives, as a result, the point or points for which the function S reaches its maximum value.

This discretization coordinate ζ_{j*}^{k*} makes it possible to separate a range of values of a context parameter into two sub-ranges. The process of recursive division of the space of the context parameters can stop when, for example, at least one of the two following conditions is met, making it possible to conclude that the threshold relating to the health indicator CI is statistically constant over these two sub-ranges.

For a first condition, a minimum number of values required to estimate a quantile distribution is reached.

For a second condition, a hypothesis H0, according to which two means of quantile distributions are no longer statistically different, cannot be rejected. The hypothesis H0 can be written as follows: μ_{τ}_{₁}=μ_{τ}_{₂}. In particular, this hypothesis H0 cannot be rejected if the value of the Welch's t-test statistic Sⱼ(k) is less than the critical value estimated from the inverse distribution of Student's t-distribution according to a probability level α. A low value of the parameter α favors acceptance of the hypothesis H0.

This estimated critical value is, for example, equal to

$${t}^{- 1} ( 1 - \frac{α}{2} , ν ) ,$$

wherein ν is the number of degrees of freedom such that:

$$ν = ⌊ \frac{( {N}_{b} - 1 ) \cdot {( {Σ}_{{τ}_{1}} + {Σ}_{{τ}_{2}} )}^{2}}{{Σ}_{{τ}_{1}}^{2} + {Σ}_{{τ}_{2}}^{2}} ⌋ .$$

This number ν of degrees of freedom conditions the critical value of the Welch's t-test statistic and depends on the variance of the quantile sample and the dimension of Q_{τ}.

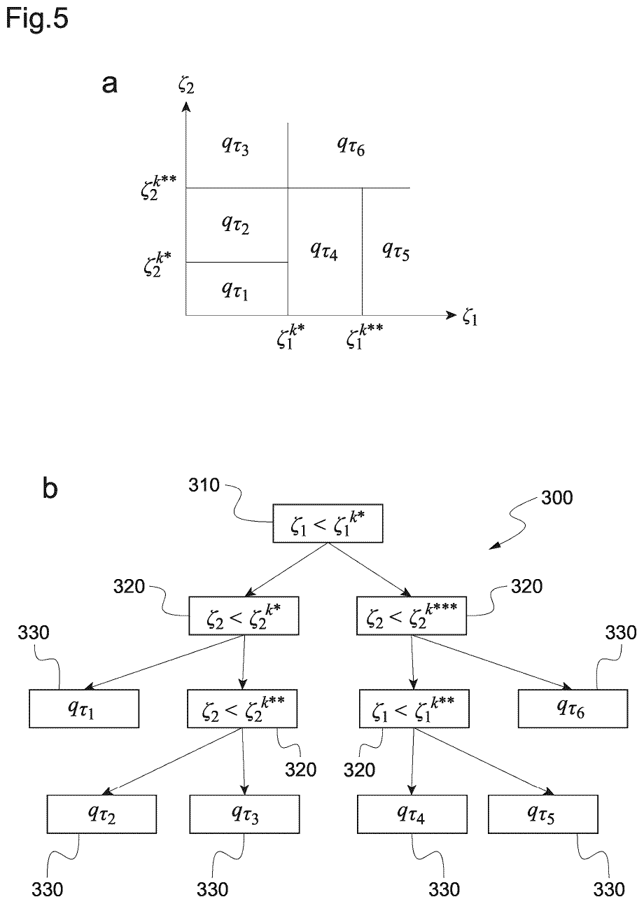

The construction and use of a decision tree 300 is based on the notion of Boolean choice enabling a direction to be taken in the space of the context parameters, as shown in FIG. 5 with an example of a single decision tree 300. Boolean choices only concern the root node 310 and the decision nodes 320. The root node 310 is the first node of the decision tree 300 from which the decision nodes 320 are derived. For a pair of context parameters or a single context parameter, if the condition analyzed at a node 310,320 is true, the left-hand branch is followed. If not, the right-hand branch must be followed. This rule is repeated until a leaf node 330 is reached containing the parameters of the quantile distributions.

Irrespective of the number of decision trees 300, the estimations of the root node 310, the decision nodes 320 and the leaf nodes 330 follow the following procedure using the data set D={x,ζ}.

The example shown in FIG. 5 relates to a single decision tree 300 and a space of two context parameters, Z={ζ1,ζ2}.

A minimum number Nm of values x of the health indicator CI conditioned on the context parameters ζ, and a maximum number Nγ of gamma distributions for the mixture model, must be fixed.

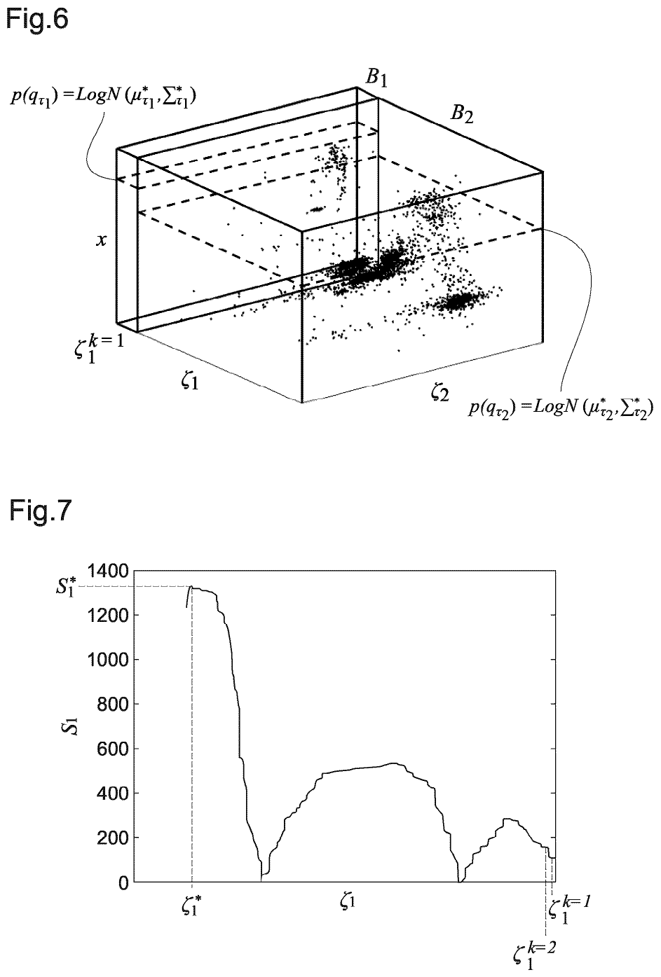

At the first iteration, k=1, the data block comprising the values x of the health indicator CI as a function of the two context parameters ζ₁, ζ₂ is split into two data blocks B1,B2 at the coordinate ζ₁^{k=1} while complying with the condition of a minimum number Nm of values x of the health indicator CI conditioned on the first context parameter ζ1, as shown in FIG. 6.

A mixture model of gamma distributions is estimated for each data block B1,B2, according to the relationship p(x)=Σₙ₌₁^{K}πₙ.p(x;αₙ,βₙ). The means μ_{τ}_{₁} and μ_{τ}_{₂} and the variances Σ_{τ}_{₁} and Σ_{τ}_{₂} are estimated at a probability level τ. The Welch's t-test statistic Sⱼ(k) is also calculated.

Next, the following iteration, k=2, is carried out, the context parameter ζ1 being incremented (ζ₁^{k=2}).

The process is thus carried out again for the first context parameter ζ1, successively splitting the data blocks for each iteration until at least one of the two abovementioned conditions is met.

Next, the process is also carried out for the second context parameter ζ2.

A maximum value of the Welch's t-test statistic may be determined over the entire space of the context parameters, the discretization coordinate ζ_{j*}^{k*} being defined as equal to this maximum value S*₁ of the Welch's t-test statistic, as shown in FIG. 7.

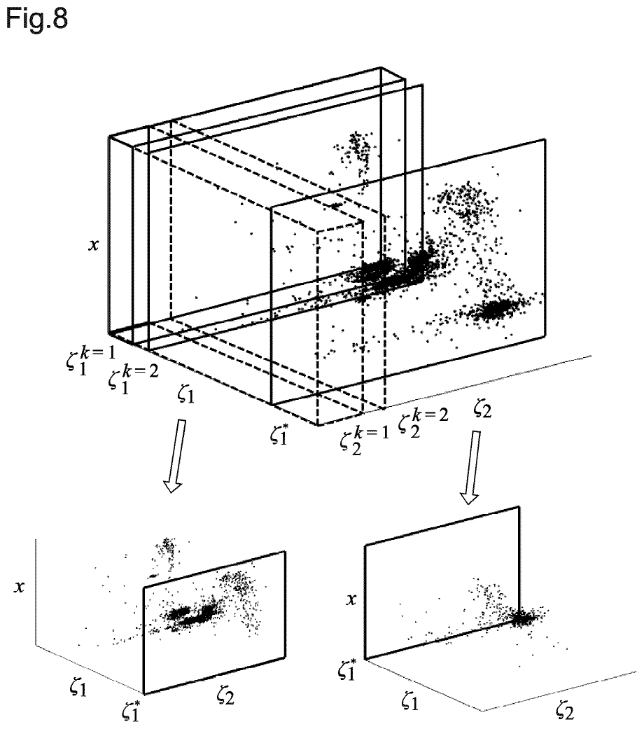

The values x of the health indicator CI are then separated, according to a two-dimensional discretization of the health indicator CI for each of the two context parameters ζ1,ζ2, into two subsets referred to, for example, as “data sets”, with the value and context parameter determined previously. FIG. 8 shows such a two-dimensional discretization as a function of the context parameters ζ₁ and ζ₂ according to the process of constructing a decision tree. The two left-and right-hand blocks are separated at the coordinate ζ*₁.

A decision node 320 of the decision tree 300 is then created, or indeed a root node 310 if it is the first node of the tree 300.

The complete process is then repeated to create each decision node 320 of the decision tree 300. For each branch, this process ends with the creation of a leaf node 330, if the value of the Welch's t-test statistic is less than the critical value of the estimated Welch's t-test statistic

$$( {t}^{- 1} ( 1 - \frac{α}{2} , ν ) )$$

or if the minimum number of values for the health indicator CI is reached in one of the blocks B1,B2.

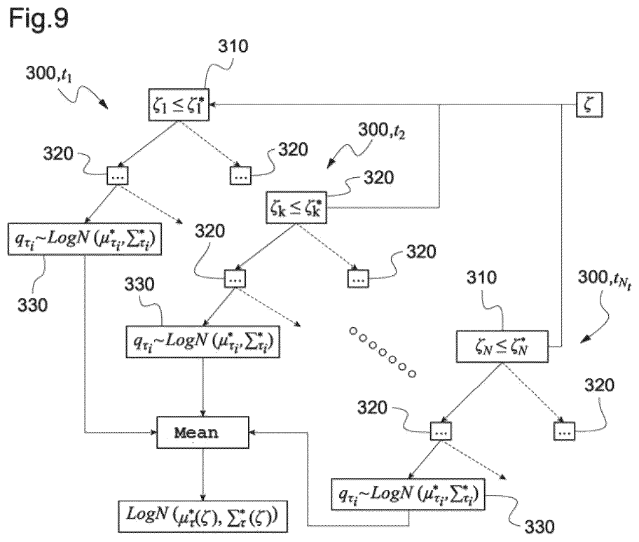

The procedure for constructing a single decision tree 300 is therefore complete when each branch ends with a leaf node 330. An example using an aggregation of Nt decision trees t₁, . . . , t_{N}_{ₜ} is shown in FIG. 9, the procedure for constructing such a set of Nt decision trees being similar.

Several decision trees may then be estimated. For each decision tree, a random selection is made from the data formed by a health indicator CI and a set of context parameters D^{N}^{ₜ}={x,ζ}^{N}^{ₜ}. Nₜ corresponds to the number of random selections required to produce a set of decision trees T={t₁, t₂ . . . t_{N}_{ₜ}}.

The various decision trees constructed in this way can then be used during the operational phase 200 by averaging the parameters of the quantile distributions of each traversed decision tree for a value x of the health indicator CI and the associated context parameter values ζ.

Using the decision tree or trees 300, the function ƒ(ζ) can then be estimated after correlating the quantile distributions as a function of the context parameters ζ. Once the function ƒ(ζ) has been estimated, it is then possible to predict, for set of context parameters ζ or a single context parameter ζ, the parameters of the associated quantile distributions.

For a new set of context parameters ζ or a single context parameter ζ, each decision tree t comprises a leaf node l(ζI,t).

The quantile distribution predicted over all of the Nt decision trees for a set of context parameters ζ is then written as follows: p(q_{τ}(ζ)) =ƒ(ζ)=Log N(μ*_{τ}(ζ),Σ*_{τ}(ζ)).

A mean μ*_{τ}_{ᵢ} and a variance Σ*_{τ}_{ᵢ} of the quantile distribution can be estimated at the leaf node l(ζI,t) satisfying the condition [symbol] _{ζ∈{l(ζ}_{_{I}}_{,t}_{ᵢ}_{)}.}

The mean μ*_{τ}(ζ) can be written as follows:

$${μ}_{τ}^{*} ( ζ ) = \frac{1}{{N}_{t}} {Σ}_{i = 1}^{{N}_{t}} {s}_{i}^{μ} ( ζ , t ) .$$

In particular, the value of the mean of the quantile associated with the leaf node l(ζI,t) of the tree t as a function of the context parameter or parameters ζ is then sᵢ^{μ}(ζ,t)= [symbol] _{ζ∈{l(ζ}_{_{I}}_{,t}_{ᵢ}_{)}}μ*_{τ}_{ᵢ} i=1, . . . , Nₜ.

The variance Σ*_{τ}_{ᵢ} contains the mean of the variances of the Nt decision trees and the variance of the estimate of the mean over all of the generated decision trees such that:

$${Σ}_{τ}^{*} ( ζ ) = \frac{1}{{N}_{t}} {Σ}_{i = 1}^{{N}_{t}} {s}_{i}^{Σ} ( ζ , t ) + \frac{1}{{N}_{t}} {Σ}_{i = 1}^{{N}_{t}} {( {s}_{i}^{μ} ( ζ , t ) - {μ}_{τ}^{*} ( ζ ) )}^{2} .$$

In particular, the value of the variance of the quantile associated with the leaf node l(ζI,t) of the tree t as a function of the context parameter or parameters ζ is written as follows:

$${s}_{i}^{Σ} ( ζ , t ) = {𝟙}_{ζ ∈ \{ l ( {ζ}_{I} , {t}_{i} ) \}} {Σ}_{{τ}_{i}}^{*} i = 1 , … , {N}_{t} .$$

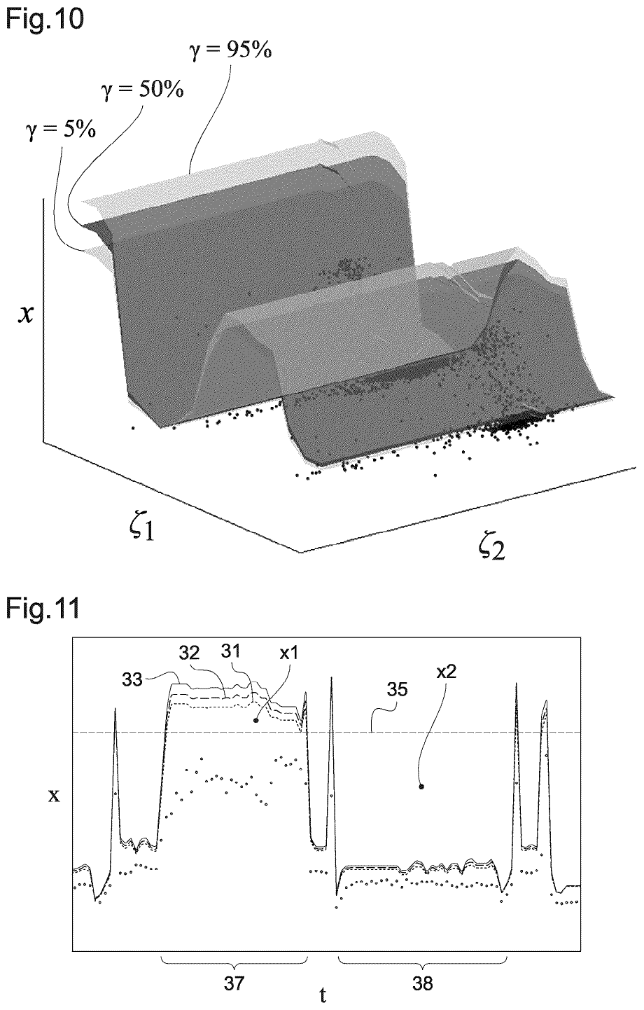

In this way, a variable threshold model H(τ,ζ,γ) as shown in FIG. 10 may be defined for a value x of the health indicator CI as a function of two context parameters ζ1,ζ2 with a probability level τ of false alarms equal to 0.9999 and with three different levels of confidence, also referred to as levels of uncertainty γ, respectively equal to 0.05 (5%), 0.55 (55%) and 0.95 (95%).

Once the initial phase 100 has been carried out and the threshold variation model established, the operational monitoring phase 200 can be carried out at each use of the vehicle 1 involving the operation of the mechanical system 10, as long as no major maintenance operation is carried out that is likely to jeopardize the reliability of the threshold variation model of a mechanical system 10 of the vehicle 1. The operational monitoring phase 200 comprises the following steps.

During a step of taking measurements 220, successive operational vibration values and operational context values from the vibration sensor or sensors 20 and the context sensor or sensors 25 respectively are measured and transmitted to the memory 6,6′ in order to be stored there and/or possibly transmitted directly to the calculator 50.

This step of taking measurements 220 is similar to the step of taking measurements 120 of the successive initial vibration values and initial context values from the vibration sensor or sensors 20 and the context sensor or sensors 25 respectively.

Next, during a determination step 230, several operational health values of each health indicator CI are determined in a conventional manner as a function of the operational vibration values, by means of the calculator 50. This determination step 230 is similar to the step of determining 130 several initial health values of each health indicator CI, and each operational health value of a health indicator CI is associated with one of the operational context values of one or several context parameters.

As with the determination step 130, the step of determining 230 several operational health values of each health indicator CI may be carried out by the computing unit 51 on board the vehicle 1, while the vehicle 1 is being used, for example, or by the computing unit 55 of the station 40 after the vehicle 1 has stopped. Each operational value of a health indicator CI may then be stored either in the memory 6,6′ present in the vehicle 1, or in the memory 56 of the station 40.

Next, during a determination step 250, a threshold specific to the operational health value of each health indicator CI is determined using the threshold variation model and the associated operational context value or values.

FIG. 11 shows values x of a health indicator CI as a function of time t, and curves 31,32,33 showing the variation in the threshold relating to this health indicator CI with a level of uncertainty γ equal to 0.05, 0.55 and 0.95 respectively and with a probability level τ of false alarms equal to 0.9999. By way of comparison, an algebraically constant threshold 35 estimated, for example, from an inverse cumulative distribution of a Gaussian distribution with a probability level τ=0.9999 is also shown.

It can be seen that the threshold variation curves 31,32,33 may be higher or lower than the algebraically constant threshold 35, depending on the time windows. For example, over a first time window 37, the algebraically constant threshold 35 is lower than the threshold variation curves 31,32,33 and therefore more penalizing in terms of potentially triggering false alarms.

Finally, during a triggering step 260, an alert is triggered to indicate, to an operator or pilot of the vehicle 1, a risk of presence of a fault in the mechanical system 10 if the operational health value of each health indicator CI is greater than the determined threshold.

As a result, the detection of a fault in the mechanical system 10 can be anticipated in a reliable, effective and robust manner from the first signs of its occurrence, as the presence of this fault can be detected through the vibrations of this mechanical system 10.

For example, using one of the threshold variation curves 31,32,33 shown in FIG. 11 therefore advantageously avoids the generation of a false alarm for a value x1 of the health indicator CI. Using one of the threshold variation curves 31,32,33 also avoids the non-detection of a potential fault for a value x2 of the health indicator CI.

Naturally, the present disclosure is subject to numerous variations as regards its implementation. Although several embodiments are described above, it should readily be understood that it is not conceivable to identify exhaustively all the possible embodiments. It is naturally possible to replace any of the means described with equivalent means without going beyond the ambit of the present disclosure and the claims.

What is claimed is:

1. A method for monitoring the health of a mechanical system equipping a vehicle, the mechanical system comprising at least one moving member and at least one vibration sensor emitting a vibration signal, the mechanical system or the vehicle comprising at least one context sensor emitting a context signal relating to at least one context parameter, the context parameter(s) being chosen from a list comprising at least one or several functional parameters of the mechanical system, one or several navigation parameters of the vehicle and one or several atmospheric parameters, the method consisting of an initial phase of defining a threshold variation model as a function of the context parameter(s) followed by a phase of operational monitoring of the mechanical system, the initial phase comprising the following steps:
taking measurements of successive initial vibration values from the vibration sensor(s) and successive initial context values from the context sensor(s);
determining, with a calculator, several initial health values of at least one health indicator CI relating to the mechanical system as a function of the initial vibration values, each initial health value being associated with one of the initial context values of the context parameter(s); and
defining, for each health indicator CI, a threshold variation model, the threshold variation model being defined as a function of the initial health values of the health indicator CI and the initial context values of the context parameter(s), by partitioning a domain formed by the initial context values of the context parameter(s) into several ranges of values for which the threshold relating to the health indicator CI is statistically constant over each range of values, each range being associated with several of the initial context values, and by determining values of the threshold with the method using regressions on parameters of quantile distributions conditioned on context parameters and domain decompositions of the context parameter(s) using at least one decision tree,
the operational monitoring phase comprising the following steps during the operation of the mechanical system:
taking measurements of successive operational vibration values from the vibration sensor(s) and successive operational context values from the context sensor(s);
determining, with the calculator, an operational health value of at least one health indicator CI as a function of the operational vibration values, the operational health value of at least one health indicator CI being associated with one of the operational context values relating to one or several context parameters;
determining the threshold specific to the operational health value of the health indicator(s) CI using the threshold variation model and the associated operational context value(s); and
triggering an alert signaling a risk of presence of a fault in the mechanical system if the operational health value of the health indicator(s) CI is greater than the determined threshold.

2. The method according to claim 1,
wherein the threshold variation model is defined by aggregating at least two decision trees.

3. The method according to claim 1,
wherein the threshold variation model is defined with a predetermined minimum rate of false alarms and a predetermined level of confidence in the minimum rate of false alarms.

4. The method according to claim 1,
wherein the initial health values of the health indicator(s) CI are calculated from a decomposition, into Fourier coefficients, of the successive initial vibration values modelled with an assumption of first-and second-order cyclostationarity of the vibration signal, that follows a chi-squared distribution, generalized by a gamma distribution.

5. The method according to claim 1,
wherein the initial phase comprises an analysis step for analyzing the sensitivity of the health indicator(s) CI to the context parameters and for selecting influential context parameters.

6. The method according to claim 1,
wherein the initial phase comprises a preselection step for selecting context parameters taken into account by the method from a plurality of context parameters measured by the context sensor(s).

7. The method according to claim 1,
wherein the threshold relating to the health indicator(s) CI is considered to be statistically constant, over a range of contiguous values of a context parameter, if, for any division of the range of values into two sub-ranges of contiguous values, the thresholds estimated respectively over the two sub-ranges of values are considered identical according to a statistical test.

8. A computer program comprising instructions that, when the program is run, cause the method according to claim 1, to be implemented.

9. A monitoring device configured to monitor a mechanical system equipping a vehicle, the mechanical system comprising at least one moving member, the monitoring device comprising at least one vibration sensor emitting a vibration signal, at least one context sensor emitting at least one context signal relating to at least one context parameter and the calculator,
wherein the monitoring device is configured to implement the method according to claim 1.

10. The monitoring device according to claim 9,
wherein the calculator comprises a computing unit and a memory on board the vehicle.

11. The monitoring device according to claim 9,
wherein the calculator comprises a computing unit and a memory separate from the vehicle.

12. A mechanical system comprising at least one moving member,
wherein the mechanical system comprises the monitoring device according to claim 9.

13. An aircraft comprising the mechanical system and the monitoring device according to claim 9.
